(19) United States
(12) Patent Application Publication
(10) Pub. No.: US 2008/0065825 A1
(43) Pub. Date: Mar. 13, 2008

(54) OPTICAL STORAGE DEVICE AND DATA STORAGE METHOD THEREOF

(75) Inventors: Yao-Chun Fang, Tainan County (TW); Kuo-Lung Chien, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/530,488

(22) Filed: Sep. 11, 2006

(51) Int. Cl. G06F 12/00

(52) U.S. Cl. 711/112

(57) ABSTRACT

An optical storage device includes a pickup head, an input interface, a memory and a memory control unit. The pickup head is for reading a piece of data from a disk. The input interface has an input data processor, and the input data processor has a buffer for registering the piece of data. The memory has a number of blocks. The memory control unit includes a memory access device and a buffer valid access device. The memory access device is for reading the piece of data from the input data register and writing the piece of data into one of the blocks. The buffer valid check device is for checking whether a next written-in block is a valid block, When the next written-in block is the valid block, the buffer valid check device controls the memory access device to stop writing the piece of data into the next written-in block.

### BACKGROUND OF THE INVENTION

1. Field of the Invention

The invention relates in general to an optical storage device and data storage method thereof; and more particularly to an optical storage device having high memory usage efficiency, and data storage method thereof.

2. Description of the Related Art

In this era of digital audio/video technology, optical storage device, such as an optical disk drive or recorder, can meet the various requirements of the public in pictures or medium (such as music files) storage, audio/video edit and data backup etc. and has become a main-stream product in today's electronic market.

in ordinary application of the optical storage device, such as a decoding process of an optical disk drive, the optical disk drive searches the required data on an optical disk according to a request command of a host. After the optical disk drive finds out the targeted data, the optical disk drive continuously writes the demodulated data into a dynamic random access memory (DRAM) and then decodes the data written in the DRAM and sends the decodes data to the host for output. The DRAM has a number of blocks and the operation of writing the data into the DRAM is usually to write the data into a number of successive blocks until all the data requested by the request command are processed.

Conventionally, owing that the DRAM has relatively larger storage space, the DRAM usually stores many pieces of data. As long as the data written into the DRAM does not cover the pieces of data which are not sent out, unpredictable errors will not happen. When the optical disk drive writes the data into the DRAM and finishes writing one block, the optical disk drive judges the condition of a data writing stop and determines whether to stop writing the data to the next block. However, owing that the data is continuously written in, if the process of the data being written in the DRAM is interrupted, it needs another time-cost re-seek to retrieve the following data on the optical disc. If the DRAM has relatively larger storage space, it is able to do the other re-seek in time so that the transmission rate will not be affected.

Besides, the demodulated signal for the optical disk drive to write data into the DRAM is generated continuously. So that when the data-writing stop is ensured, the optical disk drive may have written some pieces of data into the next block, and the data written into the next block is not complete. Therefore, in a conventional resolution, a spare block is used for buffer to prevent the valid data which is not sent out in the DRAM from being covered,

If the DRAM has enough storage space, and the speed of writing data cannot catch up with the speed of demodulating and sending the data, data covering can be prevented. However, computers tend to be designed thin and small today, and consequentially the storage space of DRAM configured in the optical disk drive id smaller and smaller, and the number of blocks for storing data id reduced. Using a spare block for buffer usage will largely reduce the usage efficiency of DRAM.

### SUMMARY OF THE INVENTION

it is therefore an object of the invention to provide an optical storage device and data storage method thereof. A buffer valid check device is used to check if the next written-in block is a valid block, and the optical storage device is accordingly controlled to stop writing data into a boundary of the block. At the same time, the data sent in from the from-end process unit is temporarily stored in a buffer with less storage like an input data register and next operation is performed after the determination whether the next written-in block is a valid block. Therefore, the memory usage efficiency can be improved.

The invention achieves the above-identified object by providing an optical storage device including a pickup head, an input interface, a memory and a memory control unit. The pickup head is for reading a piece of data from a disk. The input interface has an input data processor, and the input data processor has a buffer for registering the piece of data. The memory has a number of blocks. The memory control unit includes a memory access device and a buffer valid access device. The memory access device is for reading the piece of data from the buffer and writing the piece of data into one of the blocks. The buffer valid check device is for checking whether a next written-in block is a valid block. When the next written-in block is the valid stop writing the piece of data into the next written-in block.

The invention achieves the above-identified object by providing a data storage method applied for writing a piece of data into a memory. The memory has a number of blocks, The data storage method includes reading the piece of data; writing the piece of data into a buffer; writing the piece of data into a block of the memory; determining whether a next written-in block of the memory is a valid block; and stopping writing the piece of data into the memory when the writing of the current block is finished and the next written-in block is the valid block.

The invention achieves the above-identified object by providing a data storage method for writing a piece of data into a memory, applied to an optical storage device, the optical storage device having a pickup head, a buffer, the memory, a memory access device and a buffer valid check device. The data storage method includes reading the piece of data by the pickup head; writing the piece of data into the buffer before the piece of data is written into the memory; reading the piece of data from the buffer and writing the piece of data into a block of the and the memory access device; determining whether a next written-in block of the memory is a valid block by the buffer valid check device when the last piece of data is written into a boundary of the current block; and controlling the memory access device to stop writing the data into the boundary of the block by the buffer valid check device when the next written-in block is the valid block.

A The invention achieves the above-identified object by providing a data storage method, applied for writing a piece of data into a targeted disk. The data storage method includes reading the piece of data from a host, writing the piece of data into a block of a memory; determining whether a next written-in block of the memory is a valid block; stopping writing the piece of data into the memory when writing the piece of data into the block is finished and the next written-in block is the valid block; and writing the piece of data into the targeted disk from the memory.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a flow chart of the data storage method according to a preferred embodiment of the invention.

FIG. 2A is a block diagram of the optical storage device according to the first embodiment of the invention.

FIG. 2B is a chart of the memory 210 according to the first embodiment of the invention.

FIG. 2C is another chart of the memory 210 according to the first embodiment of the invention.

FIG. 3A is a block diagram of the optical storage device according to the second embodiment oft the invention.

FIG. 3B is a chart of the memory 310 according to the second embodiment of the invention,

FIG. 4 is a chart of the memory 210 according to the third embodiment of the invention.

FIG. 5A is a block diagram of the optical storage device according to the forth embodiment of the invention.

FIG. 5B is a contracted chart of the memory 510 according to the forth embodiment of the invention.

FIG. 5C is another contracted chart of the memory 510 according to the forth embodiment of the invention.

### DETAILED DESCRIPTION OF THE INVENTION

The invention provides an optical storage device and data storage method thereof. A buffer valid check device is used to check if the next written-in block is a valid block, and the optical storage device is accordingly controlled to stop writing data into a boundary of the block. At the dame time the data sent in from the previous class is temporarily stored in a buffer with less storage like an input data register and next operation is performed after the determination whether the next written-in block is a valid block. Therefore, the memory usage efficiency can be improved.

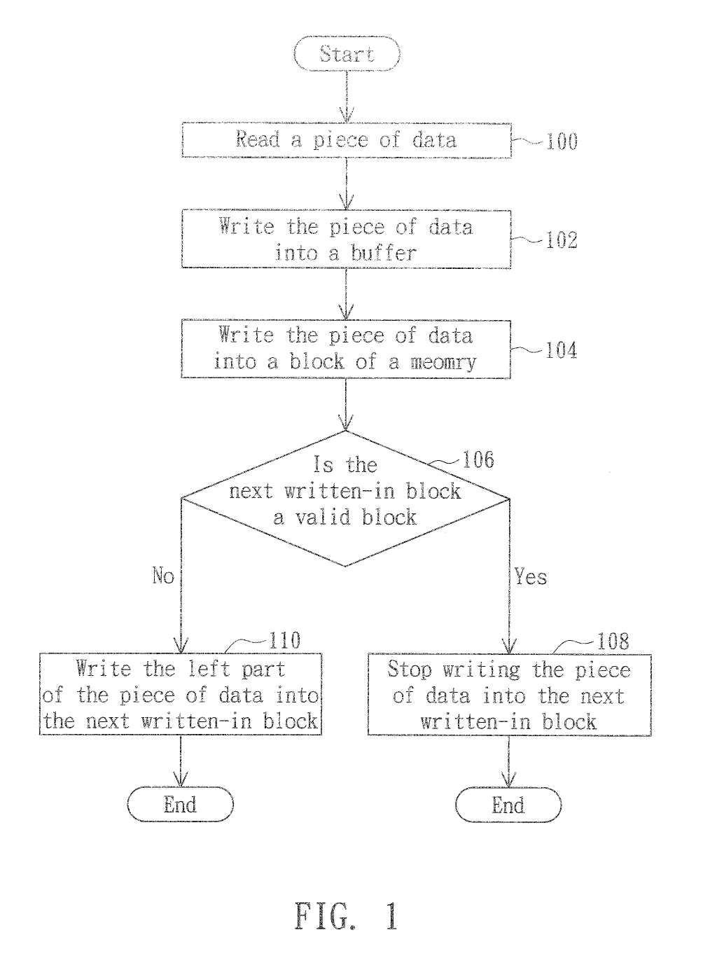

Referring to FIG. 1, a flow chart of the data storage method according to a preferred embodiment of the invention is shown. The data storage method is applied for writing a piece of data into a memory, such as a DRAM. The memory has a number of blocks.

The flow of reading data from disk according to the host request is described as follows. First, in step 100, read a piece of required data. Next, in step 102, temporarily store the piece of data into a buffer. Following that, in step 104, write the piece of data into a block of the memory. Then, in step 106, when writing the piece of data into the current block is finished, determine if the next written-in block of the memory is a valid block. The validity of the next written-in block would change according to a buffer pointer, which points the location of memory in which data read from disk will be stored, and/or a transfer pointer, which points the location of the memory from data will be transmitted to the host. Finally, when writing the piece of data into the block is finished and the next written-in block is the valid block, stop writing the data into the memory as shown in step 108. If the next written-in block is not the valid block, in step 110, continuously write the part of the piece of data into the next written-in block of the memory. When the data originally stored in the next written-in block is not transmitted, the next written-in block is defined as the valid block. Besides, the buffer in the step 102 may be a register or a SRAM.

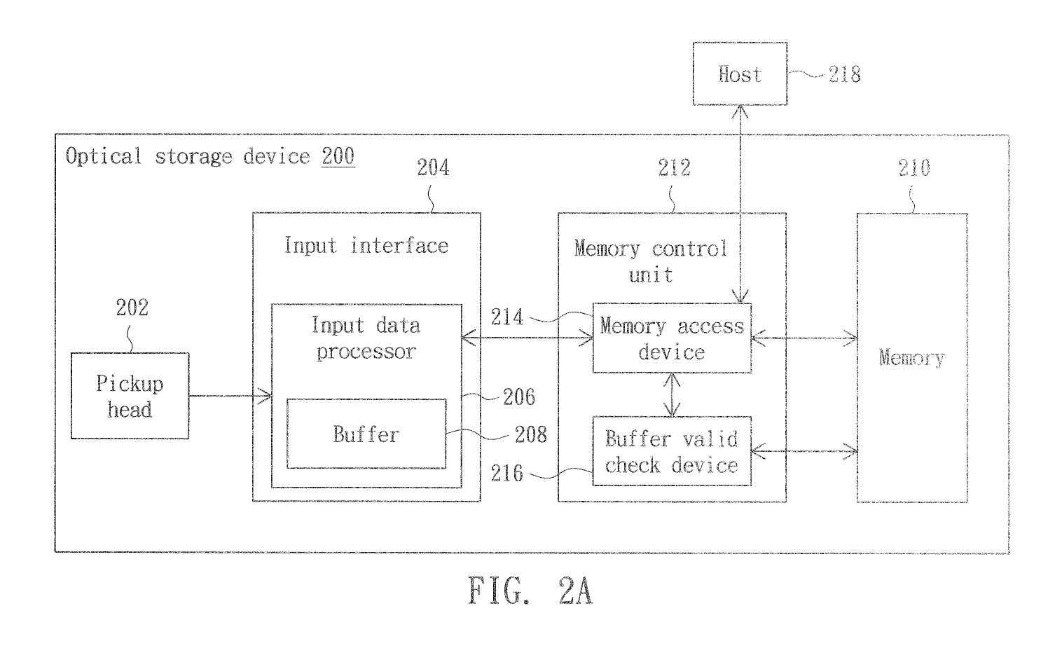

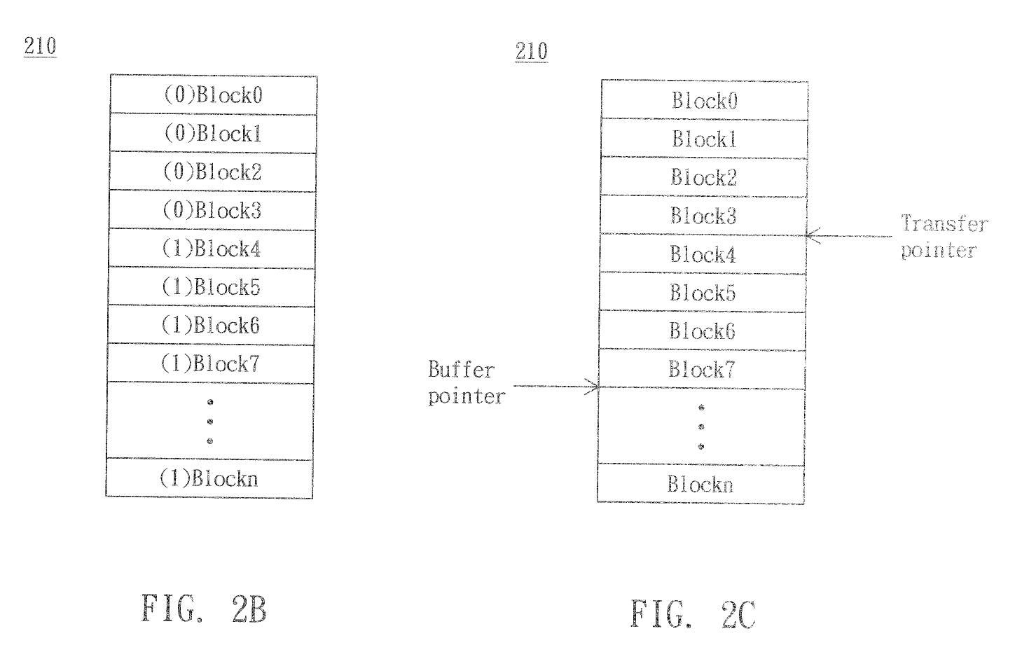

The flow of writing data onto a disk according to the host request is described as follows Referring to FIG. 2A, a block diagram of the optical storage device according to the first embodiment of the invention is shown. The optical storage device 200 includes a pickup head 202, an input interface 204, a memory 210 and a memory control unit 212. The optical storage device 200 is coupled to a host 218. The pickup head 202 is controlled via the input interface 204 to read a piece of required data on a disk according to a request command of the host 218 wherein the piece of data can be also read from the host 218. For example when writing the piece of data on a disk, the piece of data is read from the host and written onto the disk after being encoded. The input interface 204 has in input data processor 206, and the input data processor 206 has a buffer 208. In comparison with the memory 210, the buffer 208 is a memory device with less storage for registering the data read by the pickup head 202. For example, the buffer 208 may be an input data register. The buffer 208, being able to be replaced by a SRAM, is used to be a buffer of the piece of data demodulated from the host to the memory 210.

The memory 210, such as a DRAM, has a number of blocks. The memory control unit 212 includes a memory access device 214 and a buffer valid check device 216. The memory access device 214 reads data from the buffer 208 and writes the data into a block of the memory 210. When the data is written into the boundary of the block, the buffer valid check device 216 checks if the next written-in block is a valid block. When the next written-in data is the valid block, the buffer valid check device 216 controls the memory access device 214 to stop writing the data into the next written-in block. When the next written-in block is not the valid block, the memo access device 214 continuously writes the left part of the data into the next written-in block. When the data originally stored in the next written-in block is not transmitted, the next written-in block is defined as the valid block,

In the above-mentioned optical storage device 200, when the next written-in block is the valid block, a flag is given to the next written-in block, and the buffer valid check device 216 determines if the next written-in block is the valid block according to the flag. Referring to FIG. 2B, a chart of the memory 210 according to the first embodiment of the invention is shown. In the memory 210, the flag given to the valid block is 1, and otherwise the flag is 0. Besides, the buffer valid check device 216 can also determine if the next written-in block is a valid block by using other methods. Referring to FIG. 2C, another chart of the memory 210 according to the first embodiment of the invention is shown. When writing data into the block is finished, the next written-in block is given a buffer pointer, and the block where the memory access device 214 reads data and sends the data to the host 218 is given a transfer pointer. When the buffer pointer equals to the transfer pointer, it represents that the next written-in block is a block where the memory access device 214 reads data and the data in this block has not transmitted yet. That is, the next written-in block is the valid block and writing data into the memory 210 should be stopped.

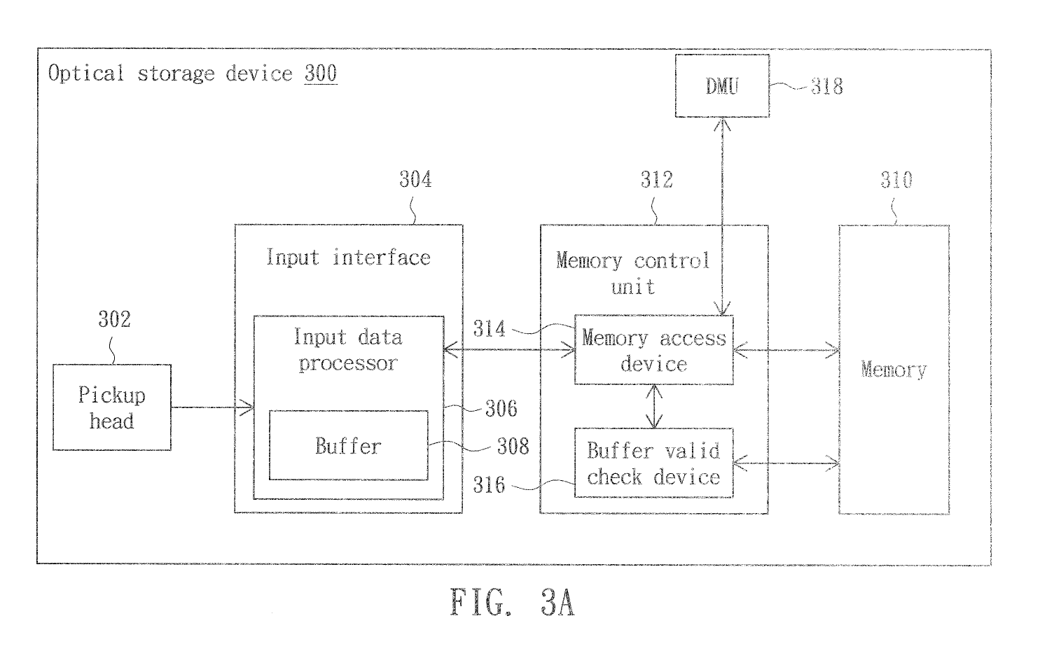

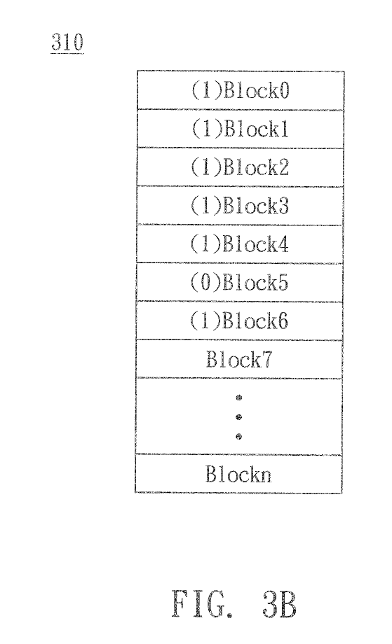

When the optical storage device is controlled by a defect management unit (DMU), not by the host, the above-mentioned data storage method is able to be applied. Referring to FIG. 3A, a block diagram of the optical storage device according to the second embodiment of the invention is shown. Compared with the optical storage device 200 in the FIG. 2A, the optical storage device 300 further includes a defect management unit 318. The defect management unit 318 is used to send out a request command to read the piece of data. Referring to FIG. 3B, a chart of the memory 310 according to the second embodiment of the invention is shown. For example, as reading a MRW disk, write the piece of data in the block 1 to block 6 of the memory 310 at the first time. If the block 5 is detected a defect, the block 5 is not the valid block. The complete data has to replace the block 5 but not to put a cover over the block 6 in the process of re-reading base to the mechanism of the linear replacement. Applied the data storage method mentioned above, setting the flag of the block 5 as 0 and otherwise as 1, it is able to stop writing data into a boundary of the block 5 without putting a cover over the block 6. Otherwise, it can reach the same purpose by applying a buffer pointer and a transfer pointer.

The above-mentioned data storage method is applied to a decoding process of an optical disk drive and can also be applied for an optical storage device such as a recorder to write data into a targeted disk. First, read a piece of required data from a host. Of course, the piece of data can also be read from a disk or a part of the data is read from the host and the left part of the data is read from the disk. Next, write the piece of data into a block of the memory is a valid block. Then, when writing the data into the block is finished and the next written-in block is the valid block, stop writing the piece of data into the memory. When the next written-in block is not a valid block, the left part of the piece of data is written into the next written-in block. Finally, write the piece of data into the targeted disk from the memory.

Mentioned to the above-mentioned data storage method, a least writing unit for writing the data into the targeted disk is N blocks, N is a positive integer. That is at least N blocks are written into the targeted disk once time. As the piece of data is written into the targeted disk by the host, have to read the left par of the data which is (N−m) blocks from the disk if the data is M blocks, wherein M=k×N+m, M, k and m are positive integers. The m blocks are not enough for N blocks. When the data of the least writing unit is enough and complete, the least writing unit will be written into the targeted disk after being encoded.

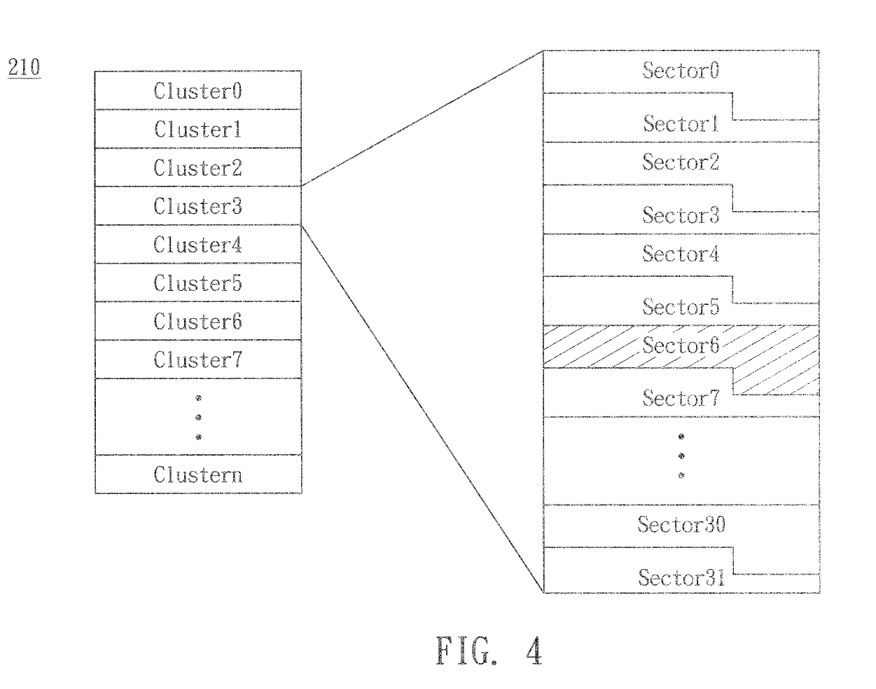

The above-mentioned data storage method largely improves the memory usage efficiency. Referring to FIG. 4, a chart of the memory 210 according to the third embodiment of the invention is shown. Take a blue ray disk (BD) for an example, the smallest block for writing data is called a cluster and each cluster includes 32 sectors. If only the data in the sixth sector of the third cluster of the disk is to be replaced, it needs only to be read from the disk the data in the region except for the sixth sector of the third cluster first and send from the host the data of the sixth sector of the third cluster to the memory. In the operation that the host sends data to the memory, the stop point for writing data should be controlled at the boundary of the block so as to prevent valid data from being covered. According to the data storage method of the invention, a flag or a pointer can used to determine whether the block is the valid block and whether to stop writing data into the boundary of the block. Therefore, the data storage method of the invention can largely improve the memory usage efficiency, not like the prior-art method, which wastes extra memory space for buffer and without need the operation of writing data into other memory first and then moving the data back.

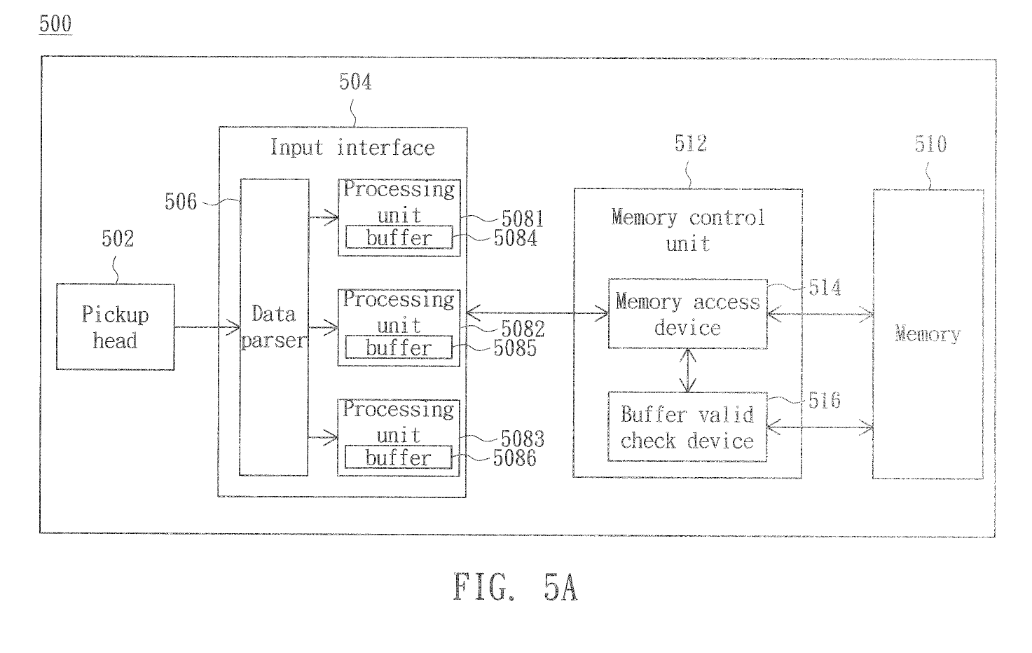

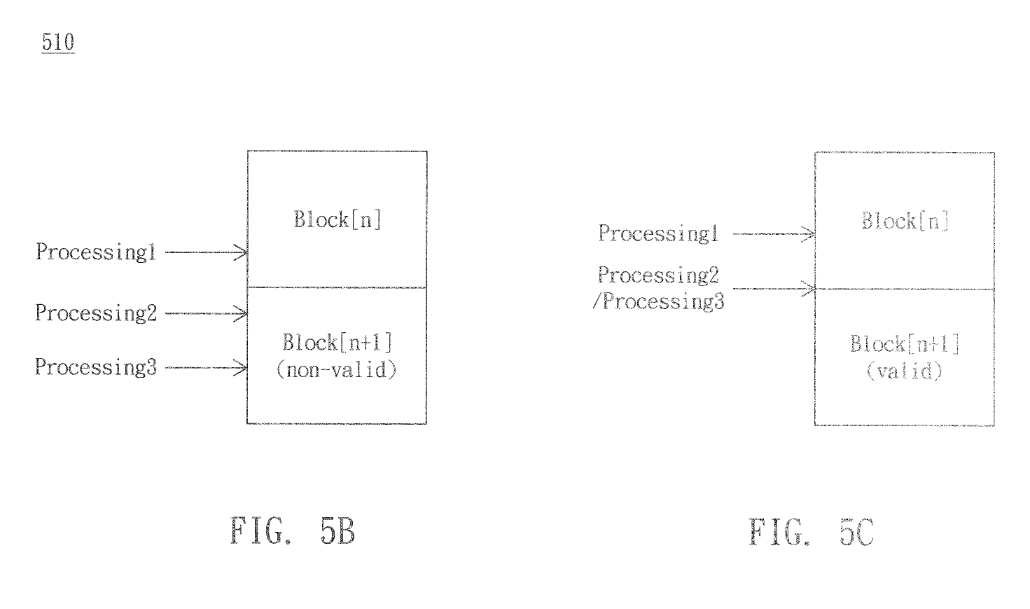

Referring to FIG. 5A, a block diagram of the optical storage device according to the forth embodiment of the invention is shown. The optical storage device 500 is substantially equal to the optical storage device 200 of the first embodiment of the invention. An input interface 504 of the optical storage device 500 includes a data parser 506 and processing units 5081˜5083, including buffers 5084˜5086. The processing units 5081˜5083 is substantially equal to the input data processor 206, as buffers 5084˜5086 equal to the buffer 208. A pickup head 502 reads a piece of data on a disk. The piece of data demodulated by the data parser 506 is transferred to the processing units 5081˜5083 according to the property of the piece of data. After delays of the processing units 5081˜5083, the piece of data and some accessory signals generated will be written in the memory 510. The delays of the processing units 5081˜5083 are not the same. Assume that the delay of the piece of data of the processing units 5081 is longer than that of the processing unit 5082, as that of the processing unit 5082 longer than that of the processing unit 5083. The pace of the writing in memory 510 can be divided into two categories corresponding to whether the next written-in block is a valid block.

Referring to FIG. 5B, a contracted chart of the memory 510 according to the forth embodiment of the invention is shown. Because the delay of the processing unit 5083 is shorter, the piece of data transferred form it will be written to the boundary of the block n in advance. As the next written-in block n+1 is not a valid block, the piece of data of the processing unit 5083 could be written in the next written-in block n+1 in advance. Referring to FIG. 5C, another contracted chart of the memory 510 according to the forth embodiment of the invention is shown. As the next written-in block n+1 is a valid block, writing the pieces of data of the processing unit 5083 and the processing unit 5082 into the memory 510 should be stopped.

Moreover, it is able to check whether the next written-in block n+1 is a valid block until the processing units 5081˜5083 all write to the boundary of the block n. When the next written-in block n+1 is a valid block, writing the piece of the data of the processing units 5081˜5083 should be stopped. Otherwise, the pieces of data of the processing units 5081˜5083 should be written into the next written-in block n+1 in turn.

Taking an optical disk as example, the piece of data demodulated can be divided a subcode and a main data. As the main data is transferred into the processing unit that proceeds Cross interleaved Reed-Solomon Code (CIRC), the subcode is written into the memory 510 earlier for the shorter delay of the processing unit related. Assume that the subcode and the main data have respectively pointers as the targets of being written into the memory 510. When the subcode of block n is written, the subcode could be written into the next written block n+1 if the next written-in block n+1 is not a valid block before the buffers 5084˜5086 are full. After the main data of the block n is written, the buffer valid check device 516 is able to check whether the next written-in block n+1 is a valid block. If the next written-in block n+1 is not a valid block, the main data could be written in the next written-in block n+1.

In the optical storage device and data storage method thereof disclosed by the above-mentioned embodiment of the invention, the buffer valid check device is used to check if the next written-in block is a valid block, and the optical storage device is accordingly controlled to stop writing data into the boundary of the block. At the same time, the data sent in form the previous class is temporarily stored in a buffer and next operation is performed after the determination whether the next written-in block is a valid block. Therefore, the memory usage efficiency can be largely improved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical storage device, comprising:
a pickup head, for reading a piece of data from a disk;
an input interface, having an input data processor, the input data
processor having a buffer for registering the piece of data;
a memory, having a plurality of blocks, and
a memory control unit, comprising:
a memory access device, for reading the piece of data from the buffer and writing the piece of data into one of the blocks; and
a buffer valid check device, for checking whether a next written-in block is a valid block;
wherein when the next written-in block is the valid block, the buffer valid check device controls the memory access device to stop writing the piece of data into the next written-in block.

2. The optical storage device according to claim 1, wherein the optical storage device is coupled to a host, the pickup head is controlled to read the piece of data via the input interface according to a request command of the host.

3. The optical storage device according to claim 2, wherein when the data originally stored in the next written-in block is not outputted to the host, the next written-in block is the valid block.

4. The optical storage device according to claim 1, wherein the next written-in block is given a flag when the next written-in block is the valid block, and the buffer valid check device determines the next written-in block to be the valid block according to the flag.

5. The optical storage device according to claim 2, wherein when writing the piece of data into a current block is finished, the next written-in block is given a buffer pointer, the block where the memory access device reads data and transmits the data to the host is given a transfer pointer, and when the buffer pointer equals to the transfer pointer, the next written-in block is the valid block.

6. The optical storage device according to claim 1, wherein when the next written-in block was detected a defect, the next written-in block is not the valid block.

7. A data storage method, applied for writing a piece of data into a memory, the memory having a plurality of blocks, the data storage method comprising:
reading the piece of data;
writing the piece of data into a buffer;
writing the piece of data into a block of the memory;
determining whether a next written-in block of the memory is a valid block; and
stopping writing the piece of data into the memory when the writing of the current block is finished and the next written-in block is the valid block.

8. The data storage method according to claim 7, wherein when the data originally stored in the next written-in block is not transmitted, the next written-in block is the valid block.

9. A data storage method, applied to an optical storage device, the optical storage device having a pickup head, a buffer, a memory, a memory access device and a buffer valid check device, the data storage method for writing a piece of data into the memory having a plurality of blocks, the data storage method comprising:
reading the piece of data by the pickup head;
writing the piece of data into the buffer before the piece of data is written into the memory;
reading the piece of data from the buffer and writing the piece of data into a block of the memory by the memory access device;
determining whether a next written-in block of the memory is a valid block by the buffer valid check device when the last piece of data is written into a boundary of the current block; and
controlling the memory access device to stop writing the data into the boundary of the block by the buffer valid check device when the next written-in block is the valid block.

10. The data storage method according to claim 9, wherein when the data originally stored in the next written-in block is not transmitted, the next written-in block is the valid block.

11. The data storage method according to claim 9, wherein when the next written-in block is not the valid block the part of the piece of data, which has not been written yet, is written into the next written-in block.

12. The data storage method according to claim 9, wherein when the next written-in block is the valid block, the next written-in block is given a flag.

13. The data storage method according to claim 9, wherein when writing the piece of data into the block is completed, the next written-in block is given a buffer pointer, the block where data is being read and transmitted is given a transfer pointer, and when the buffer pointer equals to the transfer pointer point the next written-in block is the valid block.

14. The data storage method according to claim 9, wherein when the next written-in block was detected a defect, the next written-in block is not the valid block.

15. A data storage method, applied for writing a piece of data into a targeted disk, the data storage method comprising:
reading the piece of data from a host,
writing the piece of data into a block of a memory;
determining whether a next written-in block of the memory is a valid block;
stopping writing the piece of data into the memory when writing the piece of data into the block is finished and the next written-in block is the valid block; and
writing the piece of data into the targeted disk from the memory.

16. The data storage method according to claim 15, wherein when the data originally stored in the next written-in block is not written in the targeted disk, the next written-in block is the valid block.

17. The data storage method according to claim 15, wherein when the next written-in block is not the valid block, the part of the piece of data, which has not been written yet, is written into the next written-in block and the piece of data is written into the targeted disk from the memory.

18. The data storage method according to claim 15, wherein when the next written-in block is the valid block, the next written-in block is given a flag.

19. The data storage method according to claim 15, wherein when writing the piece of data into the block is completed, the next written-in block is given a buffer pointer, the block where data is being read and transmitted is given a transfer pointer, and when the buffer pointer equals to the transfer pointer point, the next written-in block is the valid block.

20. The data storage method according to claim 15, wherein when the next written-in block was detected a defect, the next written-in block is not the valid block.
